(19) United States
(12) Patent Application Publication
(10) Pub. No.: US 2013/0003540 A1
(43) Pub. Date: Jan. 3, 2013

(54) POWER MANGEMENT TECHNIQUES FOR AN INPUT/OUTPUT (I/O) SUBSYSTEM

(76) Inventors: Poh Thiam Teoh, Kuala Lumpar (MY); Su Wei Lim, Klang (MY)

(21) Appl. No.: 13/175,557

(22) Filed: Jul. 1, 2011

(51) Int. Cl. H04L 12/26

(52) U.S. Cl. 370/230

(57) ABSTRACT

A method and system to improve the power management for an I/O subsystem. In one embodiment of the invention, the power management of an upstream port of the I/O subsystem is improved by increasing the upstream link utilization when the upstream port is an active power state and by increasing or prolonging the power saving period of the upstream port when the upstream port is in a low power state.

### FIELD OF THE INVENTION

This invention relates to an I/O subsystem, and more specifically but not exclusively, to the power management techniques for the I/O subsystem.

### BACKGROUND DESCRIPTION

FIG. 1 illustrates a block diagram 100 of a prior art I/O subsystem 110. The prior art I/O subsystem 110 has an upstream port 120 and the downstream ports 1-4 130, 140, 150 and 160. The I/O data is routed among the upstream port 120 via the communication links 125 and 170 and the downstream ports 1-4 130, 140, 150 and 160 via their respective communication links 135, 145, 155 and 165.

While waiting for packets from each of the downstream ports 1-4 130, 140, 150 and 160, the upstream port 120 typically remains in a full power-up state. This causes the I/O subsystem to consume high power even when the upstream port 120 is not servicing any of the downstream ports 1-4 130, 140, 150 and 160.

### BRIEF DESCRIPTION OF THE DRAWINGS

The features and advantages of embodiments of the invention will become apparent from the following detailed description of the subject matter in which:

FIG. 1 illustrates a block diagram of a prior art I/O subsystem;

FIG. 2 illustrates a block diagram of an I/O subsystem in accordance with one embodiment of the invention;

FIG. 3 illustrates a block diagram of an I/O subsystem in accordance with one embodiment of the invention;

FIG. 4 illustrates a flow chart of the operations of an I/O subsystem in accordance with one embodiment of the invention; and

FIG. 5 illustrates a system to implement the methods disclosed herein in accordance with one embodiment of the invention.

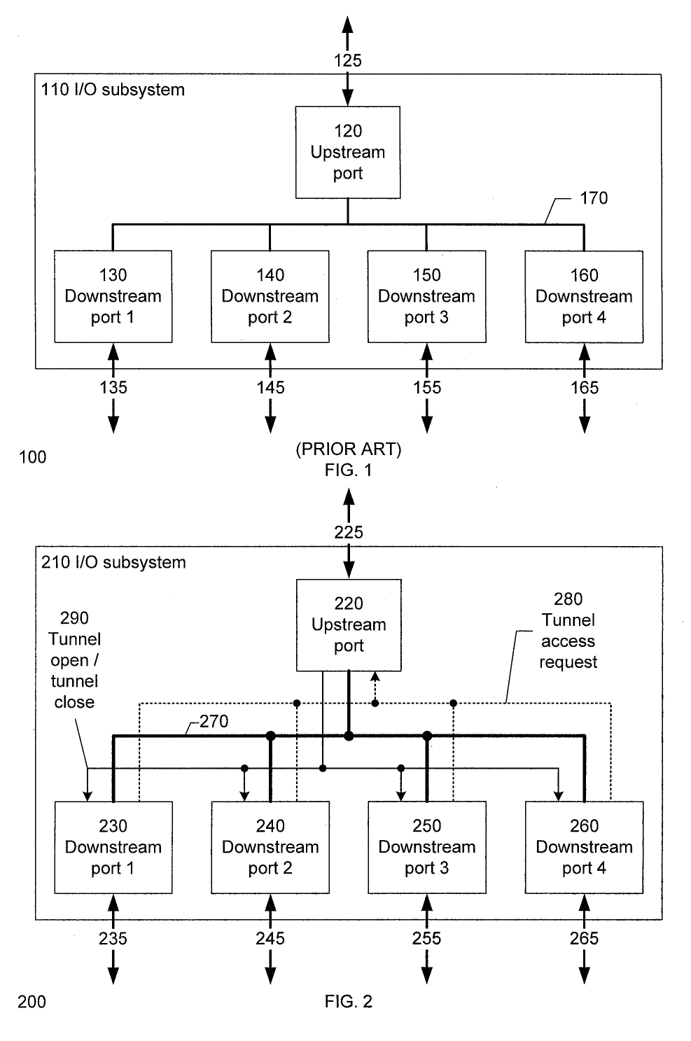

### DETAILED DESCRIPTION

Embodiments of the invention described herein are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements. Reference in the specification to “one embodiment” or “an embodiment” of the invention means that a particular feature, structure, or characteristic described in connection with the embodiment is included in at least one embodiment of the invention. Thus, the appearances of the phrase “in one embodiment” in various places throughout the specification are not necessarily all referring to the same embodiment.

The terms “upstream” and “downstream” are used to illustrate the direction of the traffic or data flow in the I/O subsystem in one embodiment of the invention and are not meant to be limiting. The terms “upstream” and “downstream” may be interchanged in another embodiment of the invention. Other terminology to describe the direction of the traffic or data flow in the I/O subsystem can be used without affecting the workings of the invention.

Embodiments of the invention provide power management techniques for an I/O subsystem. In one embodiment of the invention, the power management of the upstream port in the I/O subsystem is improved by increasing the upstream link utilization when the upstream port is an active power state and by increasing or prolonging the power saving period of the upstream port when the upstream port is in a low power state.

For example, in one embodiment of the invention, the upstream port indicates to its coupled downstream port(s) whether the upstream port is accepting data from the downstream port(s). When the upstream port determines that it is not accepting data from the downstream port(s), the upstream port indicates to its downstream port(s) that it is not accepting data and enters a low power or inactive state in one embodiment of the invention. When the upstream port determines that it is accepting data from the downstream port(s), the upstream port switches to a high power or active state and indicates to its downstream port(s) that it is accepting data in one embodiment of the invention.

The downstream port(s) coupled with the upstream port receives the indication from the upstream port that indicates whether the upstream port is accepting data from the downstream port(s). When a downstream port receives an indication that the upstream port is not accepting data, it stores or accumulates or buffers the data packets that it receives from its downstream communication link and does not send any data to the upstream port in one embodiment of the invention.

When a downstream port receives an indication that the upstream port is accepting data, it sends the stored or accumulated the data packets to the upstream port in one embodiment of the invention. The downstream port keeps sending all its stored or accumulated or buffered data packets to the upstream port until it does not have any stored data packets or when it receives the indication that the upstream port is not accepting data.

In one embodiment of the invention, a downstream port sends an indication to the upstream port to indicate whether the downstream port is ready to send its stored one or more received data packets. For example, in one embodiment of the invention, when a downstream port has received the indication that the upstream port is not accepting data, it stores the data packets that it receives from its downstream communication link and compares the stored data packets with one or more thresholds. The threshold includes, but is not limited to, a time-based threshold, a level-based threshold, a percentage of unused or unfilled buffer space in the downstream port, a percentage of filled or used buffer space in the downstream port and the like.

When a particular downstream port has determined that its one or more thresholds have been met or exceeded, it sends the indication to the upstream port that it is ready to send its stored data packets. The indication from the particular downstream port is a request for permission for the particular downstream port and other downstream port(s) (if any) to send its stored data packets to the upstream port in one embodiment of the invention.

The upstream port receives the indication from the particular downstream port and it determines whether the upstream port is able to grant permission to the particular downstream port to send its stored data packets to the upstream port in one embodiment of the invention. When the upstream port determines that it is able to accede to the request of the particular downstream port to send its stored data packets, it switches to an active power state and sends the indication to the particular downstream port that the upstream port is accepting data in one embodiment. In another embodiment of the invention, the upstream port sends the indication to the particular downstream and all the other coupled downstream ports. This allows the upstream port to service all its coupled downstream ports at the same time in one embodiment of the invention.

By using the indications between the upstream port and the downstream port(s) to manage the data or traffic flow, the I/O subsystem is able to increase the upstream link utilization when the upstream port is an active power state and it increases the power saving period of the upstream port when the upstream port is in a low power state in one embodiment of the invention.

In one embodiment of the invention, the I/O subsystem is compliant at least in part with the Peripheral Component Interconnect (PCI) Express (PCIe) standard or specification maintained by the PCI Special Interest Group (PCI-SIG). For example, in one embodiment of the invention, the I/O subsystem is compliant at least in part with, but not limited to, the PCIe base specification revision 2.0, the PCIe base specification revision 3.0 and future releases of the PCIe base specification. One of ordinary skill in the relevant art will readily appreciate that the I/O subsystem may be compliant with other wired or wireless communication protocols without affecting the workings of the invention.

The I/O subsystem is part of a switch module in one embodiment of the invention. For example, in the one embodiment of the invention, the I/O subsystem is a fully compliant PCIe switch. The I/O subsystem is part of a bridge module in one embodiment of the invention. In yet another embodiment of the invention, the I/O subsystem is integrated with a logic device. For example, in one embodiment of the invention, the I/O subsystem is a Platform Control Hub or subsystem that has an upstream Direct Memory Interface (DMI) port and multiple downstream PCI Express root ports.

In one embodiment of the invention, the I/O subsystem is compliant at least in part with the power states of the advanced configuration and power interface specification (ACPI standard, “Advanced Configuration and Power Interface Specification”, Revision 4.0a, published Apr. 5, 2010). In another embodiment of the invention, the I/O subsystem is compliant at least in part with earlier and/or future revisions of the ACPI standard.

FIG. 2 illustrates a block diagram 200 of an I/O subsystem 210 in accordance with one embodiment of the invention. The I/O subsystem 210 has an upstream port 220 and four downstream ports 1-4 230, 240, 250 and 260. The communication link 270 facilitates I/O data to be routed among the upstream port 220 and four downstream ports 1-4 230, 240, 250 and 260 in one embodiment of the invention.

In one embodiment of the invention, the I/O subsystem 210 has a tunnel access request interface or communication link 280 and a tunnel open/tunnel close interface or communication link 290. The tunnel access request interface 280 facilitates each of the downstream ports 1-4 230, 240, 250 and 260 to send an indication to the upstream port 220 to indicate whether the downstream ports 1-4 230, 240, 250 and 260 are ready to send its stored one or more received data packets.

The tunnel open/tunnel close interface or communication link 290 facilitates the upstream port 220 to send an indication to the downstream ports 1-4 230, 240, 250 and 260 to indicate whether the upstream port 220 is accepting data from the downstream ports 1-4 230, 240, 250 and 260.

In one embodiment of the invention, the I/O subsystem 210 uses the voltage of a respective signal as the respective indication for the tunnel access request interface 280 and the tunnel open/tunnel close interface 290. For example, in one embodiment of the invention, when the upstream port 220 sets a logic low voltage on the tunnel open/tunnel close interface 290, the logic low voltage serves as an indication to the downstream ports 1-4 230, 240, 250 and 260 that the upstream port 220 is not accepting data from the downstream ports 1-4 230, 240, 250 and 260. When the upstream port 220 sets a logic high voltage on the tunnel open/tunnel close interface 290, the logic high voltage serves as an indication to the downstream ports 1-4 230, 240, 250 and 260 that the upstream port 220 is accepting data from the downstream ports 1-4 230, 240, 250 and 260.

Similarly, in one embodiment of the invention, when one or more of the downstream ports 1-4 230, 240, 250 and 260 set a logic low voltage on the tunnel access request interface 280, the logic low voltage serves as an indication to the upstream port 220 that one or more of the downstream ports 1-4 230, 240, 250 and 260 are not ready to send its stored one or more received data packets. When one or more of the downstream ports 1-4 230, 240, 250 and 260 set a logic high voltage on the tunnel access request interface 280, the logic low voltage serves as an indication to the upstream port 220 that one or more of the downstream ports 1-4 230, 240, 250 and 260 are ready to send its stored one or more received data packets.

In another embodiment of the invention, the I/O subsystem 210 uses a respective register setting as the respective indication for the tunnel access request interface 280 and the tunnel open/tunnel close interface 290. For example, in one embodiment of the invention, the upstream port 220 has a register that can be set by any of the downstream ports 1-4 230, 240, 250 and 260 via the tunnel access request interface 280. The setting of the register in the upstream port 220 serves as an indication to the upstream port 220 whether one or more of the downstream ports 1-4 230, 240, 250 and 260 are ready to send its stored one or more received data packets.

Similarly, in one embodiment of the invention, each of the downstream ports 1-4 230, 240, 250 and 260 has a register can be set by the upstream port 220 via the tunnel open/tunnel close interface 290. The setting of the register in each of the downstream ports 1-4 230, 240, 250 and 260 serves as an indication to each of the downstream ports 1-4 230, 240, 250 and 260 whether the upstream port 220 is accepting data from the downstream ports 1-4 230, 240, 250 and 260.

One of ordinary skill in the relevant will readily appreciate other ways for the upstream port 220 and the downstream ports 1-4 230, 240, 250 and 260 to send indications or notifications to each other and these other ways can be used without affecting the workings of the invention. For example, in one embodiment of the invention, the tunnel access request interface 280 and the tunnel open/tunnel close interface 290 are part of the communication link 270.

The configuration of the I/O subsystem 210 is not meant to be limiting and other configurations of the I/O subsystem 210 can be used without affecting the workings of the invention. For example, in one embodiment of the invention, there can be any number of downstream ports and upstream port(s).

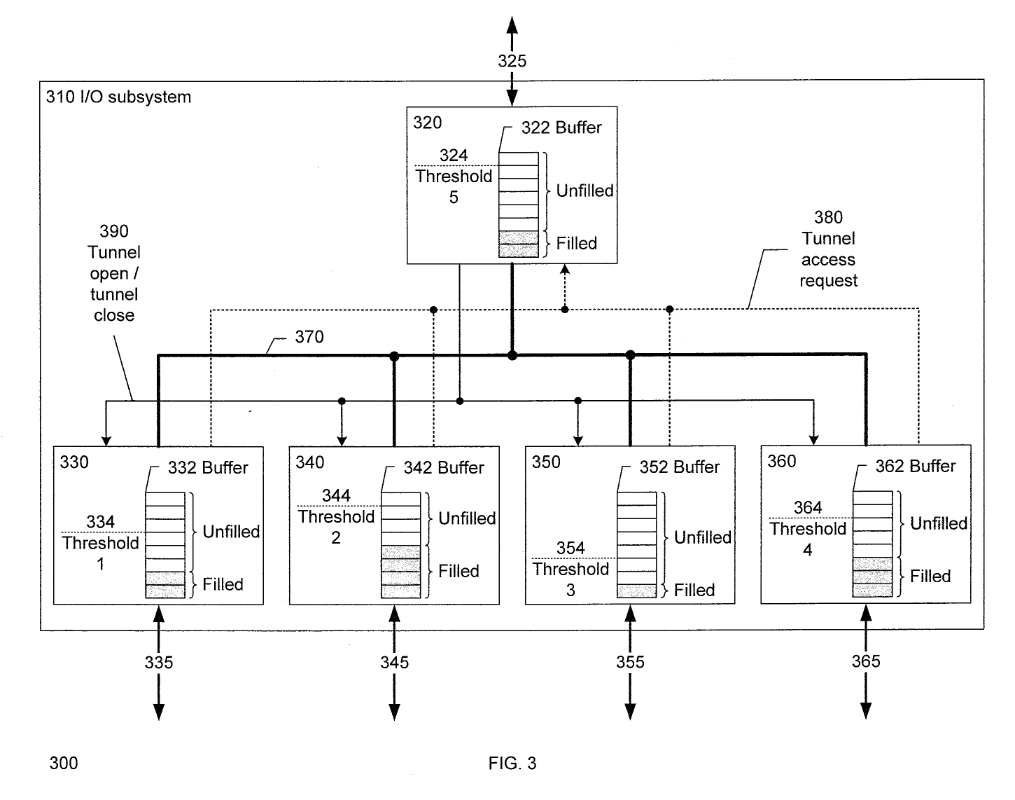

FIG. 3 illustrates a block diagram 300 of an I/O subsystem 310 in accordance with one embodiment of the invention. The I/O subsystem 310 has an upstream port 320 and four downstream ports 1-4 330, 340, 350 and 360. The communication link 370 facilitates I/O data to be routed among the upstream port 320 and four downstream ports 1-4 330, 340, 350 and 360 in one embodiment of the invention. In one embodiment of the invention, the I/O subsystem 310 has a tunnel access request interface or communication link 380 and a tunnel open/tunnel close interface or communication link 390.

In one embodiment of the invention, the downstream ports 1-4 330, 340, 350 and 360 have the buffers 332, 342, 352 and 362 respectively. Each of the buffers 332, 342, 352 and 362 stores data received from the communication links 335, 345, 355 and 365 respectively. In one embodiment of the invention, each of the buffers 332, 342, 352 and 362 stores data packets that have passed a check that includes, but not limited to, a cyclic redundancy check and any other data checking algorithm. In one embodiment of the invention, the I/O subsystem is compliant with the PCIe specification and the downstream ports 1-4 330, 340, 350 and 360 store transaction layer packets in the buffers 332, 342, 352 and 362 respectively.

When the downstream ports 1-4 330, 340, 350 and 360 receives the indication from the upstream port 320 via the tunnel open/tunnel close interface 390 that the upstream port 320 is not accepting data, the downstream ports 1-4 330, 340, 350 and 360 stores all received data packets in the buffers 332, 342, 352 and 362 respectively. Each downstream port 1-4 330, 340, 350 and 360 has the thresholds 1-4 334, 344, 354 and 364 respectively in one embodiment of the invention. Each downstream port 1-4 330, 340, 350 and 360 uses the thresholds 1-4 334, 344, 354 and 364 respectively to determine whether it is ready to send its stored one or more received data packets in one embodiment of the invention.

In one embodiment of the invention, the thresholds 1-4 334, 344, 354 and 364 are the same type of threshold. In one embodiment of the invention, the thresholds 1-4 334, 344, 354 and 364 are a combination of different types of threshold. In one embodiment of the invention, the thresholds 1-4 334, 344, 354 and 364 have the same setting or value. In one embodiment of the invention, the thresholds 1-4 334, 344, 354 and 364 have different setting or value as shown in FIG. 3. In yet another embodiment of the invention, each downstream port 1-4 330, 340, 350 and 360 uses more than one threshold to determine whether it is ready to send its stored one or more received data packets.

Each of the downstream ports 1-4 330, 340, 350 and 360 checks if its respective threshold (s) has been met. When the respective threshold(s) of a particular downstream port is met, the particular downstream port sends an indication to the upstream port 320 via the tunnel access request interface 380 that the particular downstream port is ready to send its stored one or more received data packets.

For example, in one embodiment of the invention, each downstream port 1-4 330, 340, 350 and 360 has a programmable time-based threshold and a programmable level-based threshold. In one embodiment of the invention, the programmable time-based threshold and the programmable level-based threshold are configured based on the usage model of the downstream port which is linked to, but not limited to, the device functional latency requirements, performance factors and other requirements.

Each downstream port 1-4 330, 340, 350 and 360 checks whether the programmable time-based threshold or the programmable level-based threshold has been met. If either one of the thresholds is met, the downstream port sends an indication to the upstream port 320 via the tunnel access request interface 380 that it is ready to send its stored one or more received data packets.

In one embodiment of the invention, each downstream port 1-4 330, 340, 350 and 360 measures the time that has lapsed since it has started storing or buffering its received data packets and compares the lapsed time with the programmable time-based threshold. If it determines that the lapsed time has exceeded the programmable time-based threshold, it sends an indication to the upstream port 320 via the tunnel access request interface 380 that it is ready to send its stored one or more received data packets.

Each downstream port 1-4 330, 340, 350 and 360 can set the programmable time-based threshold based on the latency requirements of the data that it has received. Each downstream port 1-4 330, 340, 350 and 360 may set the time-based threshold based on the type of the packet in one embodiment of the invention. For example, in one embodiment of the invention, each downstream port 1-4 330, 340, 350 and 360 sets a low time-based threshold when it has received audio data packets that have a low latency requirement.

In one embodiment of the invention, each downstream port 1-4 330, 340, 350 and 360 sets the programmable level-based threshold to a fraction or percentage of the total buffer area that can be used to store data packets. Each downstream port 1-4 330, 340, 350 and 360 determines the size of the stored received data packets and compares the size of the stored received data packets with the programmable level-based threshold. For example, in one embodiment of the invention, a particular downstream port can set the level-based threshold to 80% of the total available buffer area that can be used to store data packets.

In another embodiment of the invention, each downstream port 1-4 330, 340, 350 and 360 sets the programmable level-based threshold to a fraction or percentage of the available or unfilled buffer area that can be used to store data packets. Each downstream port 1-4 330, 340, 350 and 360 determines the size of the unused or unfilled buffer area and compares size of the unused or unfilled buffer area with the programmable level-based threshold. For example, in one embodiment of the invention, a particular downstream port can set the level-based threshold to 20% of the available buffer area that can be used to store data packets.

One of ordinary skill will readily appreciate that other ways of selecting and setting the threshold(s) for each downstream port 1-4 330, 340, 350 and 360 can be used without affecting the workings of the invention and these other ways shall not be described herein.

The upstream port 320 receives the indication from the particular downstream port and switches to an active power state so that it can service all the downstream ports 1-4 330, 340, 350 and 360 in one embodiment of the invention. After the upstream port 220 has switched to the active power state, it sends an indication to the downstream ports 1-4 330, 340, 350 and 360 via the tunnel open/tunnel close interface 390 that the upstream port 320 is accepting data.

When the downstream ports 1-4 330, 340, 350 and 360 receives the indication from the upstream port 320 via the tunnel open/tunnel close interface 390 that the upstream port 320 is accepting data, the downstream ports 1-4 330, 340, 350 and 360 sends all its stored received data packets in the buffers 332, 342, 352 and 362 respectively to the upstream port 320.

The downstream ports 1-4 330, 340, 350 and 360 keep sending all its stored received data packets to the upstream port 320 until it has no more stored received data packets or until it has received the indication from the upstream port 320 via the tunnel open/tunnel close interface 390 that the upstream port 320 is not accepting data. The upstream port 220 has a buffer 322 that stores incoming data packets from the downstream ports 1-4 330, 340, 350 and 360 in one embodiment of the invention.

The upstream port 220 has a threshold 5 324 to determine whether it can accept or reject data from the downstream ports 1-4 330, 340, 350 and 360 in one embodiment of the invention. In another embodiment of the invention, the upstream port 220 has more than one threshold to determine whether it can accept or reject data from the downstream ports 1-4 330, 340, 350 and 360. When the upstream port 220 has determined using the threshold 5 324 to determine that it cannot accept data from the downstream ports 1-4 330, 340, 350 and 360, it sends the indication via the tunnel open/tunnel close interface 390 to the downstream ports 1-4 330, 340, 350 and 360.

After sending the indication to the downstream ports 1-4 330, 340, 350 and 360 that it is not accepting data, the upstream port 320 enters into a low power state in one embodiment of the invention. The upstream port 320 always try its best to accumulates cycles internally in the I/O subsystem 310 in order to burst its transaction or to remain idle for a longer period in one embodiment of the invention. The downstream ports 1-4 330, 340, 350 and 360 behave as normal until the communication tunnel or upstream transaction path is closed. In this case, the downstream ports 1-4 330, 340, 350 and 360 tries its best to participate to accumulate cycles to the best effort it can achieve.

In one embodiment of the invention, the I/O subsystem 310 maximizes the period of time when the upstream port 320 resides in a low power state and it directly increases the effective low power management state of the upstream port 320 and the I/O subsystem 310.

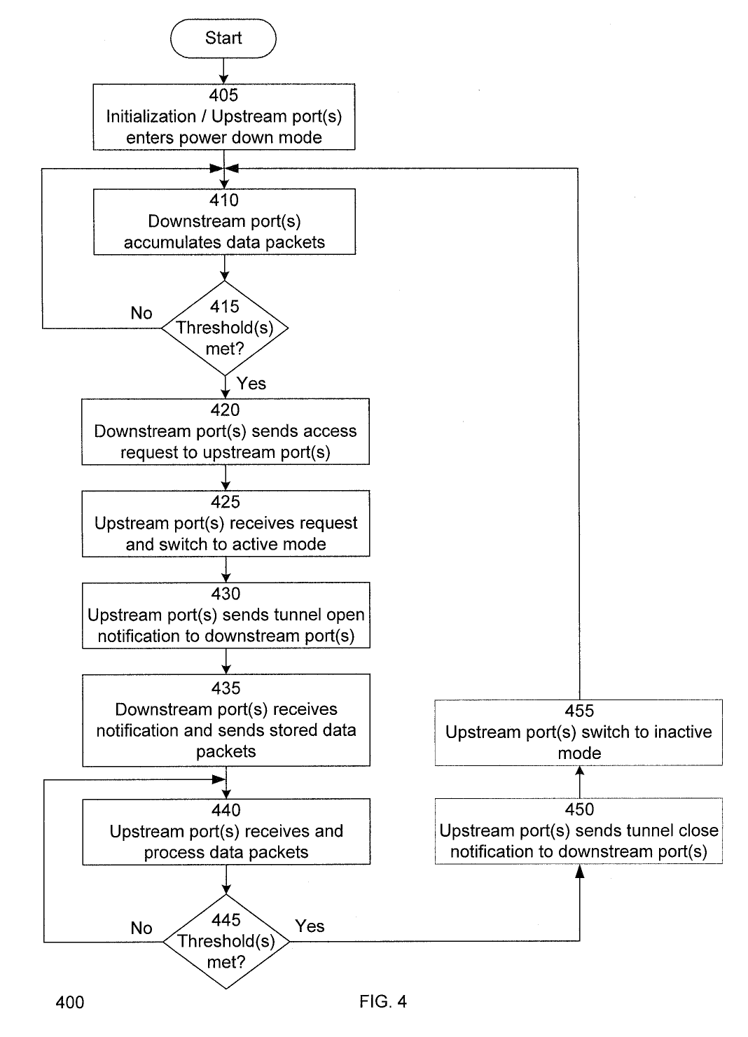

FIG. 4 illustrates a flow chart 400 of the operations of an I/O subsystem in accordance with one embodiment of the invention. For clarity of illustration, FIG. 4 is discussed with reference to FIG. 3. In step 405, the flow 400 performs initialization of the I/O subsystem 310. In one embodiment of the invention, in step 405, the initialization includes, but is not limited to, sending an indication by the upstream port 320 to the downstream ports 1-4 330, 340, 350 and 360 via the tunnel open/tunnel close interface 390 that the upstream port 320 is not accepting data, and entering or switching into a low power mode by the upstream port 320.

In step 410, the downstream ports 1-4 330, 340, 350 and 360 receive the notification from the upstream port 320 and accumulate the data packets that it has received. In step 415, each of the downstream ports 1-4 330, 340, 350 and 360 checks if its threshold(s) for the accumulated data packets has been met or exceeded. If no, the flow 400 goes back to step 410. If yes, the flow 400 goes to step 420 where the particular downstream port that has its threshold(s) met or exceeded sends an access request to the upstream port 320.

In step 425, the upstream port 320 receives the access request and switches to an active mode. In step 430, the upstream port 320 sends a tunnel open notification or indication to all the downstream ports 1-4 330, 340, 350 and 360. In step 435, the downstream ports 1-4 330, 340, 350 and 360 receives the notification from the upstream port 320 and sends its stored data packets to the upstream port 320. In step 440, the upstream port 320 receives the stored data packets from the downstream ports 1-4 330, 340, 350 and 360.

In step 445, the upstream port 320 checks if its threshold(s) has been met or exceeded. If no, the flow 400 goes back to step 440. If yes, the flow 400 goes to step 450 where the upstream port 320 sends a tunnel close notification to the downstream ports 1-4 330, 340, 350 and 360. In step 455, the upstream port 320 switches to an inactive mode and the flow 400 goes back to step 410.

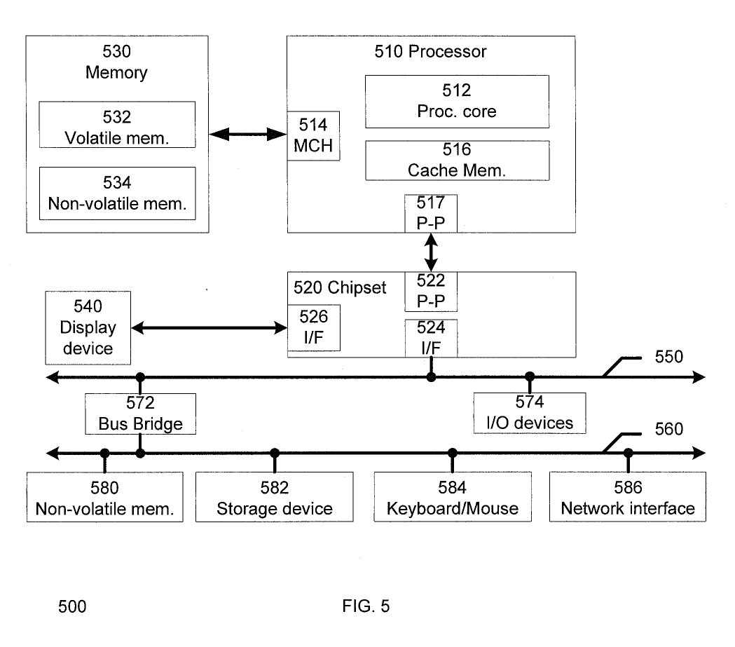

FIG. 5 illustrates a system 500 to implement the methods disclosed herein in accordance with one embodiment of the invention. The system 500 includes, but is not limited to, a desktop computer, a laptop computer, a netbook, a tablet computer, a notebook computer, a personal digital assistant (PDA), a server, a workstation, a cellular telephone, a mobile computing device, an Internet appliance or any other type of computing device. In another embodiment, the system 500 used to implement the methods disclosed herein may be a system on a chip (SOC) system.

The processor 510 has a processing core 512 to execute instructions of the system 500. The processing core 512 includes, but is not limited to, pre-fetch logic to fetch instructions, decode logic to decode the instructions, execution logic to execute instructions and the like. The processor 510 has a cache memory 516 to cache instructions and/or data of the system 500. In another embodiment of the invention, the cache memory 516 includes, but is not limited to, level one, level two and level three, cache memory or any other configuration of the cache memory within the processor 510.

The memory control hub (MCH) 514 performs functions that enable the processor 510 to access and communicate with a memory 530 that includes a volatile memory 532 and/or a non-volatile memory 534. The volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 534 includes, but is not limited to, NAND flash memory, phase change memory (PCM), read only memory (ROM), electrically erasable programmable read only memory (EEPROM), or any other type of non-volatile memory device.

The memory 530 stores information and instructions to be executed by the processor 510. The memory 530 may also stores temporary variables or other intermediate information while the processor 510 is executing instructions. The chipset 520 connects with the processor 510 via Point-to-Point (PtP) interfaces 517 and 522. In another embodiment of the invention, the chipset 520 is a platform control hub. The I/O subsystem is part of the platform control hub in one embodiment of the invention.

The chipset 520 enables the processor 510 to connect to other modules in the system 500. In one embodiment of the invention, the interfaces 517 and 522 operate in accordance with a PtP communication protocol such as the Intel® QuickPath Interconnect (QPI) or the like. The chipset 520 connects to a display device 540 that includes, but is not limited to, liquid crystal display (LCD), cathode ray tube (CRT) display, or any other form of visual display device.

In addition, the chipset 520 connects to one or more buses 550 and 560 that interconnect the various modules 574, 580, 582, 584, and 586. Buses 550 and 560 may be interconnected together via a bus bridge 572 if there is a mismatch in bus speed or communication protocol. The chipset 520 couples with, but is not limited to, a non-volatile memory 580, a mass storage device(s) 582, a keyboard/mouse 584 and a network interface 586. The mass storage device 582 includes, but is not limited to, a solid state drive, a hard disk drive, an universal serial bus flash memory drive, or any other form of computer data storage medium. The network interface 586 is implemented using any type of well-known network interface standard including, but not limited to, an Ethernet interface, a universal serial bus (USB) interface, a Peripheral Component Interconnect (PCI) Express interface, a wireless interface and/or any other suitable type of interface. The wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the system 500, the functions performed by some of these blocks may be integrated within a single semiconductor circuit or may be implemented using two or more separate integrated circuits. For example, although the cache memory 516 is depicted as a separate block within the processor 510, the cache memory 516 can be incorporated into the processor core 512 respectively. The system 500 may include more than one processor/processing core in another embodiment of the invention.

The methods disclosed herein can be implemented in hardware, software, firmware, or any other combination thereof. Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc, is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
an upstream port to:
indicate whether the upstream port is accepting data; and
enter a low power state in response to an indication that the upstream port is not accepting data.

2. The apparatus of claim 1, further comprising:
a downstream port to:
store one or more received data packets in response to receiving the indication that the upstream port is not accepting data.

3. The apparatus of claim 2, wherein the downstream port is further to:
compare the stored one or more received data packets with a threshold; and
indicate whether the downstream port is ready to send the stored one or more received data packets based on the comparison of the stored one or more received data packets with the threshold.

4. The apparatus of claim 3, wherein the threshold comprises one of a time-based threshold, a level-based threshold, and a percentage of unused buffer space in the downstream port.

5. The apparatus of claim 3, wherein the upstream port is further to:
enter an active power state in response to receiving the indication that the downstream port is ready to send the stored one or more received data; and
receive the stored one or more received data in response to entering the active power state.

6. The apparatus of claim 2, wherein the downstream port is further to:
send the store one or more received data packets in response to receiving the indication that the upstream port is accepting data.

7. The apparatus of claim 1, wherein the apparatus is compliant at least in part with a Peripheral Component Interface Express (PCIe) standard.

8. An apparatus comprising:
a downstream port to:
store one or more received data packets in response to receiving an indication that an upstream port is not accepting data;
compare the one or more stored data packets with a threshold; and
indicate whether the downstream port is ready to send the one or more stored data packets based on the comparison of the one or more stored data packets with the threshold.

9. The apparatus of claim 8, wherein the threshold is a first threshold, the apparatus further comprising:
an upstream port to: <indicate whether the upstream port is accepting data based on a second threshold; and
enter a low power state in response to the indication that the upstream port is not accepting data.

10. The apparatus of claim 9, wherein the first and the second threshold each comprises one of a time-based threshold, a level-based threshold, and a percentage of unused buffer space in the downstream port.

11. The apparatus of claim 9, wherein the upstream port is further to:
enter an active power state in response to receiving the indication that the downstream port is ready to send the stored one or more received data; and
receive the stored one or more received data in response to entering the active power state.

12. The apparatus of claim 2, wherein the downstream port is further to:
send the store one or more received data packets in response to receiving the indication that the upstream port is accepting data.

13. The apparatus of claim 8, wherein the apparatus is compliant at least in part with a Peripheral Component Interface Express (PCIe) standard.

14. A method comprising:
storing, by a downstream port, one or more received data packets in response to receiving an indication that an upstream port is not accepting data;
comparing, by the downstream port, the one or more stored data packets with a threshold; and
indicating, by the downstream port, whether the downstream port is ready to send the one or more stored data packets based on the comparison of the one or more stored data packets with the threshold.

15. The method of claim 14, wherein the threshold is a first threshold, the method further comprising:
indicate, by the upstream port, whether the upstream port is accepting data based on a second threshold; and
entering, by the upstream port, a low power state in response to the indication that the upstream port is not accepting data.

16. The method of claim 15, wherein the first and the second threshold each comprises one of a time-based threshold, a level-based threshold, and a percentage of unused buffer space in the downstream port.

17. The method of claim 15, further comprising:
entering, by the upstream port, an active power state in response to receiving the indication that the downstream port is ready to send the stored one or more received data; and
receiving, by the upstream port, the stored one or more received data in response to entering the active power state.

18. The method of claim 14, further comprising:
sending, by the downstream port, the store one or more received data packets in response to receiving the indication that the upstream port is accepting data.

19. The method of claim 14, wherein the downstream port and the upstream port apparatus are each compliant at least in part with a Peripheral Component Interface Express (PCIe) standard.
